(19) United States
(12) Patent Application Publication
(10) Pub. No.: US 2025/0013413 A1
(43) Pub. Date: Jan. 9, 2025

(54) IMAGE DISPLAY METHOD AND APPARATUS, AND ELECTRONIC DEVICE

(71) Applicant: Beijing Bytedance Network Technology Co., Ltd., Beijing (CN)

(72) Inventor: Jian HUANG, Beijing (CN)

(21) Appl. No.: 18/888,794

(22) Filed: Sep. 18, 2024

Related U.S. Application Data
(63) Continuation of application No. PCT/CN2023/095759, filed on May 23, 2023.

(30) Foreign Application Priority Data
May 24, 2022 (CN) 202210575075.7

(51) Int. Cl. G06F 3/14; G06T 3/40

(52) U.S. Cl. CPC G06F 3/14; G06T 3/40

(57) ABSTRACT

The present disclosure relates to the technical field of display, and provides an image display method and apparatus and an electronic device. The method comprises: in response to a change in the number of interaction objects, obtaining a parent view size and an actually acquired size of a current camera; when the parent view size is different from the actually acquired size, obtaining at least one acquired size supported by the current camera; determining a target size according to the parent view size and the at least one acquired size; and updating the parent view size to be the target size according to the target size, and adjusting the actually acquired size of the current camera to be the target size.

### CROSS-REFERENCE TO RELATED APPLICATIONS

The present application is a continuation application of international application No. PCT/CN2023/095759, which is based on and claims priority to CN application No. 202210575075.7 filed on May 24, 2022, the disclosures of both applications are incorporated by reference herein in their entireties.

### TECHNICAL FIELD

The present disclosure relates to the field of display technologies, and in particular an image display method and apparatus, and an electronic device.

### BACKGROUND

At present, for applications with an interaction function, such as a multi-person interaction function, a streamer will perform interaction with at least two guests after turning on the multi-person interaction function. Every time a new guest joins or exits after start of the interaction, the application needs to re-generate a new preview picture for a streamer image captured by a camera according to a new preview size.

### SUMMARY

The present disclosure provides the following technical solutions.

According to a first aspect, the present disclosure provides an image display method, comprising: acquiring a parent view size and an actual capture size of a current camera in response to a change in a number of interaction objects, wherein the parent view size is used for indicating a size of a preview box of an image of an interaction object displayed on an interaction interface; in a case where the parent view size is different from the actual capture size, acquiring at least one capture size supported by the current camera; determining a target size according to the parent view size and the at least one capture size; updating the parent view size to the target size and adjusting the actual capture size of the current camera to the above target size, according to the target size.

As one implementation of the present disclosure, the determining a target size according to the parent view size and the at least one capture size, comprises: determining at least one capture size meeting a preset condition from the at least one capture size according to the parent view size; determining the target size according to the at least one capture size meeting the preset condition and the parent view size.

As one implementation of the present disclosure, the determining the target size according to the at least one capture size meeting the preset condition and the parent view size, comprises: determining an actual difference between a width in the parent view size and that in the at least one capture size meeting the preset condition, according to the at least one capture size meeting the preset condition and the parent view size; determining a capture size corresponding to a minimum actual difference from the actual differences as the target size.

As one implementation of the present disclosure, the determining at least one capture size meeting a preset condition from the at least one capture size according to the parent view size, comprises: determining a capture size with the ratio of width to height equal to that of the parent view size from the at least one capture size, according to the parent view size.

As one implementation of the present disclosure, before the acquiring a parent view size and an actual capture size of a current camera in response to a change in the number of interaction objects, the method further comprises: in response to an interaction success instruction, acquiring the number of interaction objects who have joined the interaction.

As one implementation of the present disclosure, the target size is any one of the at least one capture size.

According to a second aspect, the present disclosure provides an image display apparatus, comprising: a processing unit for controlling an acquisition unit to acquire a parent view size and an actual capture size of a current camera in response to a change in the number of interaction objects, wherein the parent view size is used for indicating a size of a preview box of an image of the interaction object displayed on an interaction interface; wherein, the processing unit is further used for controlling the acquisition unit to acquire at least one capture size supported by the current camera, in a case where the parent view size acquired by the acquisition unit is different from the actual capture size acquired by the acquisition unit; wherein, the processing unit is further used for determining a target size according to the parent view size acquired by the acquisition unit and the at least one capture size acquired by the acquisition unit; wherein, the processing unit is further used for updating the parent view size to the target size, and adjusting the actual capture size of the current camera to the above target size, according to the target size.

As one implementation of the present disclosure, the processing unit is used for determining at least one capture size meeting a preset condition from the at least one capture size, according to the parent view size acquired by the acquisition unit; the processing unit is used for determining the target size according to the at least one capture size meeting the preset condition and the parent view size acquired by the acquisition unit.

As one implementation of the present disclosure, the processing unit is used for determining an actual difference between a width in the parent view size and that in the at least one capture size meeting the preset condition, according to the at least one capture size meeting the preset condition and the parent view size acquired by the acquisition unit; the processing unit is used for determining a capture size corresponding to a minimum actual difference from the actual differences as the target size.

As one implementation of the present disclosure, the processing unit is used for determining a capture size with the ratio of width to height equal to that of the parent view size from the at least one capture size.

As one implementation of the present disclosure, the processing unit is used for controlling the acquisition unit to acquire the number of interaction objects who have joined the interaction, in response to an interaction success instruction.

As one implementation of the present disclosure, the target size is any one of the at least one capture size.

According to a third aspect, the present disclosure provides an electronic device, comprising: a memory and a processor, wherein the memory is used for storing a computer program; the processor is used for causing, when executing the computer program, the electronic device to implement the image display method as provided in the above first aspect.

According to a fourth aspect, the present disclosure provides a computer readable storage medium, wherein, on the computer readable storage medium is stored a computer program which, when executed by a computing device, causes the computing device to implement the image display method as provided in the above first aspect.

According to a fifth aspect, the present disclosure provides a computer program product which, when operated on a computer, causes the computer to implement the image display method as provided in the above first aspect.

According to a sixth aspect, the present disclosure provides a computer program, comprising: instructions which, when executed by a processor, cause the processor to execute the image display method as provided in the above first aspect.

It should be noted that the above computer instructions can be stored entirely or partially on a first computer readable storage medium. The first computer readable storage medium can be packaged together with the processor of the image display apparatus, or can be packaged separately with the processor of the image display apparatus, which is not limited by the present disclosure.

For the descriptions of the second, third, fourth, fifth and sixth aspects in the present disclosure, please refer to the detailed description of the first aspect. Moreover, the beneficial effects described in the second, third, fourth, fifth and sixth aspects can refer to the analysis for the beneficial effect of the first aspect, and are not repeated here.

In the present disclosure, the name of the above image display apparatus does not constitute any limitation on the apparatus or functional modules per se. In actual implementations, these apparatus or functional modules can appear under other names. As long as the functions of various apparatus or functional modules are similar to the present disclosure, they fall within the scope of the claims of the present disclosure and their equivalent technologies.

These or other aspects of the present disclosure will be more concise and easy to understand in the following description.

### BRIEF DESCRIPTION OF THE DRAWINGS

The accompanying drawings, which are incorporated in and constitute a portion of the present specification, illustrate embodiments consistent with the present disclosure and serve to explain the principles of the present disclosure together with the specification.

In order to explain the technical solutions in the embodiments of the present disclosure or the related art more clearly, the drawings needed in the description of the embodiments or the related art will be briefly introduced below. Obviously, for those skilled in the art, other drawings can be also obtained according to these drawings without paying creative effort.

FIG. 1 is a diagram of network architecture to which an image display method provided by an embodiment of the present disclosure is applied;

FIG. 2 is a first schematic flow diagram of the image display method provided by the embodiment of the present disclosure;

FIG. 3 is a second schematic flow diagram of the image display method provided by the embodiment of the present disclosure;

FIG. 4 is a third schematic flow diagram of the image display method provided by the embodiment of the present disclosure;

FIG. 5 is a fourth schematic flow diagram of the image display method provided by the embodiment of the present disclosure;

FIG. 6 is a fifth schematic flow diagram of the image display method provided by the embodiment of the present disclosure;

FIG. 7 is a schematic structural diagram of an image display apparatus provided by an embodiment of the present disclosure;

FIG. 8 is a schematic structural diagram of an electronic device provided by an embodiment of the present disclosure;

FIG. 9 is a schematic structural diagram of a computer program product of the image display method provided by the embodiment of the present disclosure.

### DETAILED DESCRIPTION

In order to understand the above objects, features and advantages of the present disclosure more clearly, the solutions of the present disclosure will be further described below. It should be noted that the embodiments of the present disclosure and the features in the embodiments can be combined with each other without conflict.

In the following description, many specific details are set forth in order to fully understand the present disclosure, but the present disclosure can be practiced in other ways than those described herein. Obviously, the embodiments in the specification are only a portion of the embodiments of the present disclosure, not all of them.

It should be noted that, relational terms such as “first” and “second” herein are only used to distinguish one entity or operation from another entity or operation, and do not necessarily require or imply that there is any such actual relationship or order between these entities or operations. Moreover, terms “including”, “containing” or any other variation thereof are intended to cover non-exclusive inclusion, so that a process, method, article or device including a series of elements includes not only those elements, but also other elements not explicitly listed, or elements inherent to such process, method, article or device. Without further restrictions, an element defined by the phrase “including one . . . ” does not exclude the presence of other identical elements in the process, method, article or device including the element.

The Open Graphics Library (OpenGL) Shading Language in the embodiments of the present disclosure is a cross-language and cross-platform application programming interface (API) for rendering 2-dimensional (2D) and three-dimensional (3D) vector graphics.

As stated above, every time a new guest joins or exits after the start of the interaction, the application needs to re-generate a new preview picture for a streamer image captured by a camera according to a new preview size. The interaction includes live streaming interaction, such as co-streaming, or the like. In this case, there will be a problem that the preview image is stretched or compressed due to a large difference between the size of the streamer image and the preview size, which will affect the user experience.

In view of this, the present disclosure provides an image display method and apparatus, and an electronic device, for solving the problem that the preview picture is stretched or compressed due to the large difference between the size of the streamer image and the preview size, after the streamer turns on the multi-person interaction function.

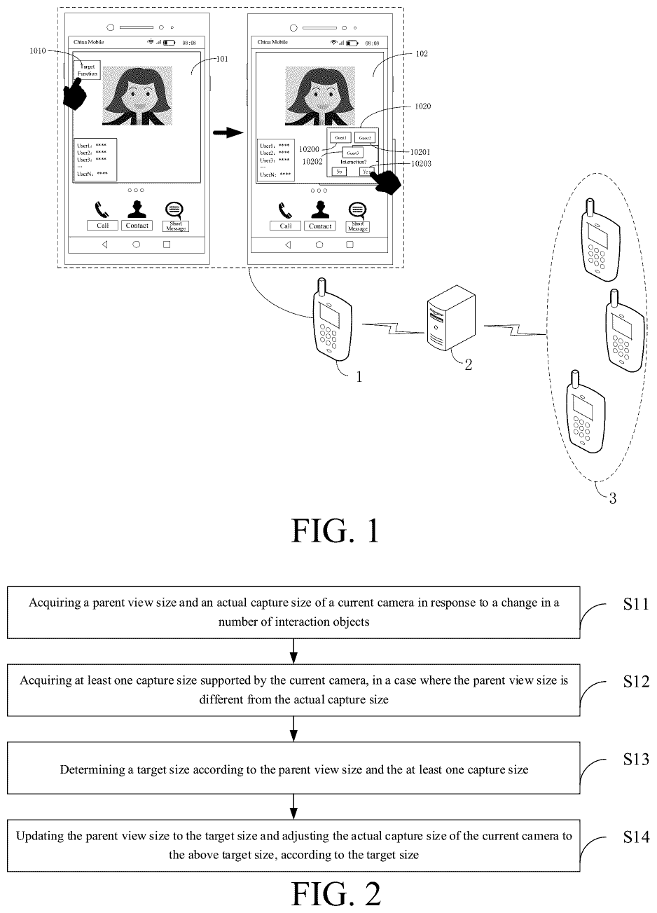

FIG. 1 is a diagram of network architecture to which an image display method provided by an embodiment of the present disclosure is applied, including: a streamer device 1, a server 2, and at least two guest devices 3. A target application that can initiate a target function is installed in the streamer device 1. After the streamer turns on the target application on the streamer device 1, a corresponding interface is entered, such as a live interface. After that, when the streamer needs to perform interaction with guest 1, guest 2 and guest 3 in the live process using the streamer device 1, the streamer can perform a selection operation on a button 1010 of the “target function” (such as multi-person interaction) in the live interface 101 displayed by the streamer device 1. After that, the streamer device 1 displays a selection interface 102, and the streamer can select a button 10200 corresponding to “Guest 1”, a button 10201 corresponding to “Guest 2”, and a button 10202 corresponding to “Guest 3” in a selection box 1020. Then, after the streamer selects “Yes” button 10203 of whether to initiate interaction, the streamer device 1 sends an interaction request to the guest device 1 used by the guest 1, the guest device 2 used by the guest 2, and the guest device 3 used by the guest 3 through a server 2, respectively. The guest device 1 used by the guest 1, the guest device 2 used by the guest 2, and the guest device 3 used by the guest 3 display corresponding prompts after they receive the interaction request sent by the streamer device 1, so that the guest 1, the guest 2, and the guest 3 can establish interaction with streamer 1. Meanwhile, in response to a change in a number of interaction objects (interaction users, i.e. users participating in interaction, including users participating in live streaming interaction), the streamer device 1 dynamically selects a suitable target size from at least one capture size supported by a current camera according to a parent view size and an actual capture size of the current camera. Therefore, it is possible to update the parent view size to a target size according to the target size, and adjust the actual capture size of the current camera to the above target size, which prevents the preview picture from being stretched or compressed.

In some examples, the streamer device 1 or the guest device 3 can be a terminal device or a server. The terminal device can be a tablet computer, a mobile phone, a notebook computer, a palmtop computer, a wearable device, an ultra-mobile personal computer (UMPC), a netbook, a personal digital assistant (PDA), a personal computer (PC), etc., which is not specifically limited in the embodiment of the present disclosure.

In the related art, the width and height of the preview box of the camera in LiveCoreSDK are set in LIveStreamConfig for an electronic device using Android system. The streamer will perform interaction with at least two guests after turning on the multi-person interaction function. After the start of the interaction, when the number of interaction objects changes (for example, there is a guest who joins or exits), the application needs to put the streamer image captured by the camera in a new preview size in form of a preview picture, and present the preview picture according to a certain display ratio. In this case, there will be a problem that the preview image is stretched or compressed due to a large difference between the width and height of the preview box of the camera set in LIveStreamConfig and the width and height of the streamer image, which will affect the user experience.

Therefore, according to the image display method provided by the embodiment of the present disclosure, when the number of interaction objects changes, it is necessary to judge a relationship between the parent view size and the actual capture size of the current camera. For example, when the parent view size is different from the actual capture size, it is necessary to determine a target size according to the parent view size and at least one capture size supported by the current camera. In this way, according to the target size, the parent view size is updated to the target size, and the actual capture size of the current camera is adjusted to the above target size. In this way, it is possible to ensure the parent view size to be consistent with the actual capture size of the current camera, thus avoiding the problem that the preview picture is stretched or compressed due to the large difference between the actual capture size and the parent view size. For example, the process of implementing the above image display method can be as follows.

The parent view size, the actual capture size of the current camera, and at least one capture size supported by the current camera involved in the present disclosure can be data authorized by the user or fully authorized by all parties.

By taking the streamer device 1 as the executing subject that executes the image display method provided by the embodiment of the present disclosure and Android system as the operating system of the streamer device 1 for example, the image display method provided by the embodiment of the present disclosure will be exemplarily explained below.

FIG. 2 is a flow diagram of an image display method shown according to one exemplary embodiment. As shown in FIG. 2, the method includes the following S11-S14.
S11, in response to a change in the number of interaction objects, acquiring a parent view size and an actual capture size of the current camera. For example, the parent view size is used for indicating a size of a preview box of an image of an interaction object displayed on an interaction interface.

In some examples, the parent view size in the image display method provided by the embodiment of the present disclosure refers to the parent ViewGroup size. For example, the parent ViewGroup size refers to the width and height of the parent ViewGroup of SurfaceView/TextureView. In order to facilitate understanding, the following example takes the parent ViewGroup size as the parent view size for example to give an illustration.

Illustratively, in combination with the example given in FIG. 1, the streamer device 1 sends an interaction request to guest device(s) corresponding to one or more guests in response to the selection operation on the target function. Then, after receiving the interaction request, the guest device will display a corresponding prompt, such as “agree to join” or “refuse to join”. The guest can select “agree to join” or “refuse to join”. After the guest selects “agree to join”, he or she can perform interaction with the streamer. In the interaction process, the guest can quit at any time. In this way, every time a guest joins or quits, the number of interaction objects will change, and the size of the preview box of the streamer in the streamer device 1 needs to be adjusted accordingly, that is, the application will reassign a new parent view size. For example, the size of the preview box includes width and height, the height of the preview box is equal to the height of the parent ViewGroup size, and the width of the preview box is equal to the width of the parent ViewGroup size. Therefore, the streamer device 1 can determine the size of the current preview box by acquiring the parent ViewGroup size.

For example, the picture displayed in the preview box is a preview picture.

For example, the capture size refers to the Width and Height of the image captured by the camera. For example, both of width and height can be in units of pixels or centimeters. Illustratively, taking pixels as the units of both width and height for example, the capture size can be 640×480, and then it can be determined that the width of the image captured by the camera is 640 pixels and the height is 480 pixels.

In some examples, in the image display method provided by the embodiment of the present disclosure, the parent ViewGroup size can be acquired by means of computer programming. For example, the same computer programming language as the parent ViewGroup size can be used to write a computer program, so as to acquire the parent ViewGroup size.

Illustratively, the computer programming language used by the parent ViewGroup size can be Java.
S12, in a case where the parent view size is different from the actual capture size, acquiring at least one capture size supported by the current camera.

In some examples, in the image display method provided by the embodiment of the present disclosure, at least one capture size supported by the current camera can be acquired by means of computer programming. For example, the same computer programming language as the drive program of the current camera is used to write a computer program to acquire at least one capture size supported by the current camera.

For example, a computer program written in the same computer programming language as the drive program of the current camera is used to acquire at least one capture size supported by the current camera.

Illustratively, the computer programming language used by the drive program of the current camera can be Java.
S13, determining a target size according to the parent view size and the at least one capture size.

For example, the target size is any one of at least one capture size.
S14, according to the target size, updating the parent view size to the target size, and adjusting the actual capture size of the current camera to the above target size.

In some examples, the parent ViewGroup size is updated to the target size through LayoutParams.

It can be learned from the above that, according to the image display method provided by the embodiment of the present disclosure, in a case where the number of interaction objects changes, it is possible to determine a suitable target size from at least one capture size supported by the current camera according to the parent view size and the actual capture size of the current camera. Therefore, it is possible to update the parent view size to the target size according to the target size, and adjust the actual capture size of the current camera to the above target size. In this way, it is possible to make the actual capture size of the current camera the same as the parent view size, which avoids the problem that the preview picture is stretched or compressed due to the large difference between the actual capture size and the parent view size.

Compared with related art, the technical solution provided by the present disclosure has the following advantages:

In a case where the number of interaction objects changes, it is possible to determine a suitable target size from at least one capture size supported by the current camera according to the parent view size and the actual capture size of the current camera. Further, it is possible to update the parent view size to the target size according to the target size, and adjust the actual capture size of the current camera to the above target size. Since the actual capture size of the current camera is the same as the parent view size, it is possible to prevent the preview picture from being stretched or compressed, which solves the problem that the preview picture is stretched or compressed due to the large difference between the size of the streamer image and the preview size, after the streamer turns on the multi-person interaction function.

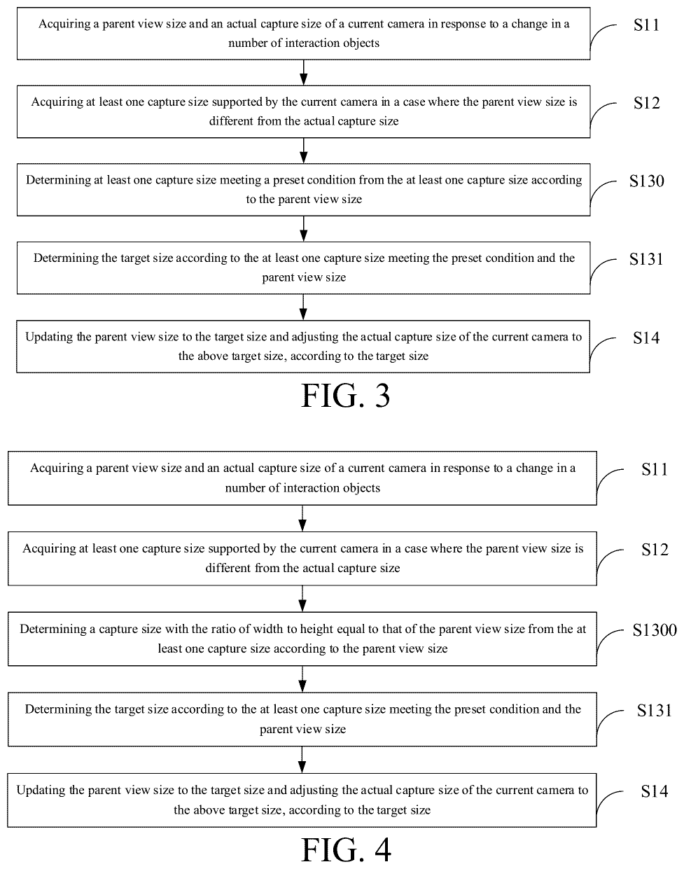

As some implementations of the present disclosure, as shown in FIG. 3 in combination with FIG. 2, the above S13 can be implemented by the following S130 and S131.
S130, according to the parent view size, determining at least one capture size meeting a preset condition among the at least one capture size.

In some examples, the preset conditions can be pre-configured or determined according to the height and width of the parent ViewGroup size. For example, the preset condition can be configured according to the type of an electronic device. For example, the same type of electronic devices corresponds to the same preset condition. In this way, it is more convenient to determine the capture size with the ratio of width to height equal to that of the parent view size. Alternatively, the preset condition is determined according to the height and width of the parent ViewGroup size, for example, the ratio of width to height of the capture size is equal to that of the parent view size.

For example, the preset condition is configured according to the type of the electronic device that displays images of the interaction objects, and the same type of electronic devices corresponds to the same preset condition.
S131, determining the target size according to the at least one capture size meeting the preset condition and the parent view size.

In some examples, one or more capture sizes meeting the preset condition can be found among the capture sizes according to the preset condition. In order to avoid the problem that the preview picture is stretched or compressed, it is necessary to search for a capture size that best matches the parent ViewGroup size among the capture sizes meeting the preset condition as the target size. For example, the actual difference between the width in the parent view size and the width in each capture size of at least one image that meets the preset condition is determined, and the capture size corresponding to the minimum actual difference is determined as the target size that best matches the parent ViewGroup size. Alternatively, the actual difference between the width in the parent view size and the width in each capture size of at least one image that meets the preset condition, and the target difference between the height in the parent view size and the height in each capture size of the at least one image that meets the preset condition are determined, and the capture size corresponding to the minimum target difference among the capture sizes having the same actual difference is determined as the target size that best matches the parent ViewGroup size.

In some embodiments, the actual difference between the width in the parent view size and the width in the at least one capture size meeting the preset condition is determined according to the at least one capture size meeting the preset condition and the parent view size; the capture size corresponding to the minimum actual difference among the actual differences is determined as the target size.

As can be learned from the above, according to the image display method provided by the embodiment of the present disclosure, at least one capture size meeting the preset condition is searched for among at least one capture size supported by the current camera by means of the parent view size. Then, the target size is determined according to the at least one capture size meeting the preset condition and the parent view size. For example, it is possible to update the parent view size to the target size according to the target size, and adjust the actual capture size of the current camera to the above target size. In this way, it is possible to make the actual capture size of the current camera the same as the parent view size, which avoids the problem that the preview picture is stretched or compressed due to the large difference between the actual capture size and the parent view size.

As some implementations of the present disclosure, as shown in FIG. 4 in combination with FIG. 3, the above S130 can be implemented by the following S1300.
S1300, according to the parent view size, determining the capture size with the ratio of width to height equal to that of the parent view size among the at least one capture size.

In some examples, there are one or more capture sizes with the same ratio of width to height as the parent view size among the capture sizes. For example, when the ratio of width to height of the parent view size is 3/4, the capture size with the same ratio of width to height as that of the parent view size can be 600*800 or 1200*1600. In this way, according to the ratio of width to height of the parent view size, the capture size with the same ratio of width to height as that of the parent view size can be searched for among the capture sizes.

As can be learned from the above, according to the image display method provided by the embodiment of the present disclosure, the ratio of width to height of the parent view size is used to search for the capture size with the same ratio. In this way, it is possible to search for a target size matching the parent view size among the capture sizes with the same ratio of width to height as that of the parent view size. For example, it is possible to update the parent view size to the target size according to the target size, and adjust the actual capture size of the current camera to the above target size. In this way, it is possible to make the actual capture size of the current camera the same as the parent view size, which avoids the problem that the preview picture is stretched or compressed due to the difference between the actual capture size and the parent view size.

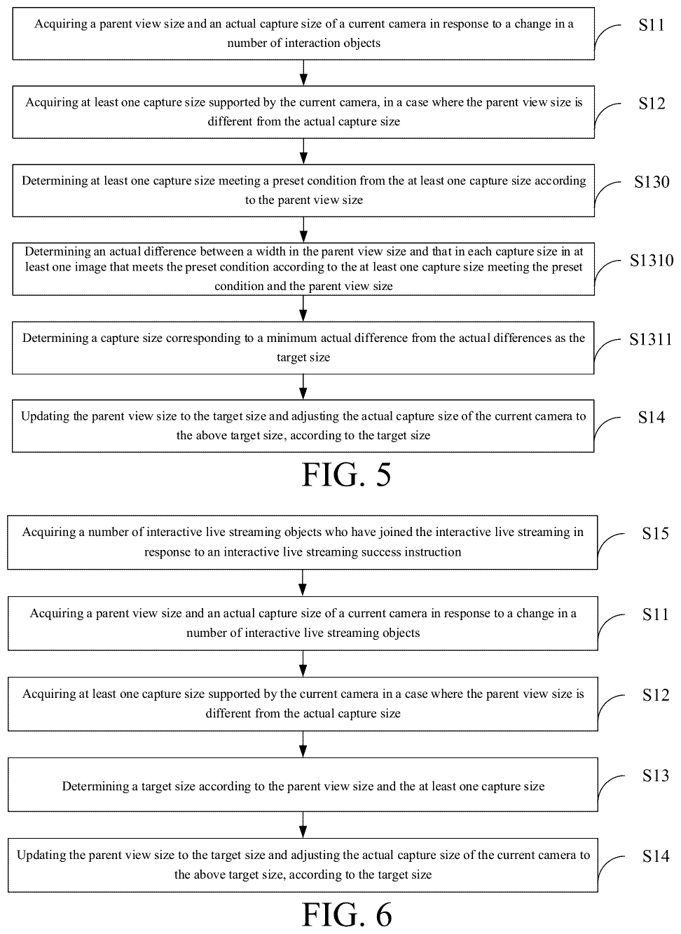

As some implementations of the present disclosure, as shown in FIG. 5 in combination with FIG. 3, the above S131 can be implemented by the following S1310 and S1311.
S1310, determining an actual difference between a width in the parent view size and that in each capture size of at least one image that meets the preset condition, according to the at least one capture size meeting the preset condition and the parent view size.

In some practices, in combination with the example given by the above S1300, when the ratio of width to height of the capture size is equal to the ratio of width to height of the parent view size, there may be a large difference between the capture size and the parent view size. In order to avoid the problem that the preview screen is stretched or compressed, it is necessary to search for a capture size that best matches the parent view size among the capture sizes with the same ratio of width to height as that of the parent view size, according to the parent view size. For example, the actual difference between the width in the parent view size and the width in each capture size of at least one image that meets the preset condition is determined, and the capture size corresponding to the minimum actual difference among the actual differences is determined as the target size. Therefore, the problem that the preview picture is stretched or compressed due to the large difference between the parent view size and the actual capture size can be avoided.
S1311, determining a capture size corresponding to a minimum actual difference among the actual differences as the target size.

As some implementations of the present disclosure, as shown in FIG. 6 in combination with FIG. 2, the image display method provided by the embodiment of the present disclosure further needs to execute S15 before S11.
S15, in response to an interaction success instruction, acquiring the number of interaction objects who have joined the interaction.

In some examples, according to the image display method provided by the embodiment of the present disclosure, after obtaining the number of interaction objects, it is further necessary to judge the relationship between the number of interaction objects and the guest threshold, so as to determine whether to execute S11. For example, in a case where the number of interaction objects is greater than the guest threshold, S11 is executed. In a case where the number of interaction objects is less than or equal to the guest threshold, S11 is not executed.

For example, in the case where the number of interaction objects is greater than the threshold, the parent view size and the actual capture size of the current camera are acquired in response to the change in the number of interaction objects.

For example, the guest threshold can be pre-configured or obtained from feedback data. For example, the guest threshold is equal to a minimum guest number that causes the preview screen to be stretched or compressed from the feedback data, so that the guest threshold can be dynamically updated to ensure the user's experience. In addition, the guest threshold can be pre-configured, for example, the guest threshold is an integer greater than or equal to 2. When the guest threshold is 2, the streamer device 1 executes S11 in the case where the number of interaction objects is greater than 2.

For example, the threshold is equal to the minimum number of interaction objects that causes a preview picture of an image of an interaction object to be stretched or compressed.

The above mainly introduces the solution provided by the embodiment of the present disclosure from the perspective of the method. In order to realize the above functions, it contains corresponding hardware structures and/or software modules for executing various functions. Those skilled in the art should easily recognize that, in combination with the units and algorithm steps of various examples described in the embodiments disclosed herein, the present disclosure can be implemented by hardware or a combination of hardware and computer software. Whether a certain function is executed exactly by hardware or by driving hardware with computer software depends on constraints of the specific application and design of the technical solution. Skilled people can use different methods to implement the described functions for each specific application, but such implementation should not be considered as going beyond the scope of the present disclosure.

The embodiment of the present disclosure can divide the image display apparatus into functional modules according to the above method examples. For example, it is possible to divide the image display apparatus into functional modules corresponding to the functions, or integrate two or more functions into one processing module. The above integrated modules can be implemented in the form of hardware or software functional modules. It should be noted that the division of modules in the embodiment of the present disclosure is schematic and only a logical functional division, and there may be another division method in the actual implementation.

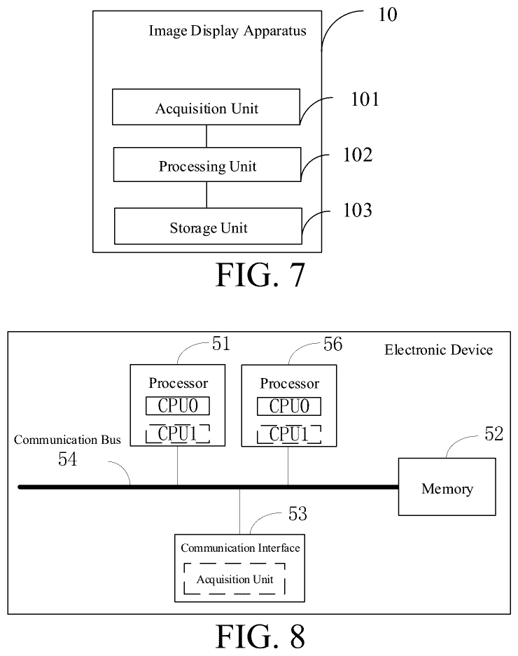

As shown in FIG. 7, an embodiment of the present disclosure provides a schematic structural diagram of an image display apparatus 10. The image display apparatus 10 includes an acquisition unit 101 and a processing unit 102.

The processing unit 102 is used for controlling an acquisition unit 101 to acquire a parent view size and an actual capture size of a current camera in response to a change in the number of interaction objects, wherein the parent view size is used for indicating a size of a preview box of an image of an interaction object displayed on an interaction interface; the processing unit 102 is further used for controlling the acquisition unit 101 to acquire at least one capture size supported by the current camera, in a case where the parent view size acquired by the acquisition unit 101 is different from the actual capture size acquired by the acquisition unit 101; the processing unit 102 is further used for determining a target size according to the parent view size acquired by the acquisition unit 101 and the at least one capture size acquired by the acquisition unit 101; the processing unit 102 is further used for updating the parent view size to the target size according to the target size, and adjusting the actual capture size of the current camera to the target size.

As some implementations of the present disclosure, the processing unit 102 is used for determining at least one capture size meeting a preset condition among the at least one capture size, according to the parent view size acquired by the acquisition unit 101; the processing unit 102 is used for determining the target size according to the at least one capture size meeting the preset condition and the parent view size acquired by the acquisition unit 101.

As some implementations of the present disclosure, the processing unit 102 is used for determining an actual difference between a width in the parent view size and that in the at least one capture size meeting the preset condition, according to the at least one capture size meeting the preset condition and the parent view size acquired by the acquisition unit 101; the processing unit 102 is used for determining a capture size corresponding to a minimum actual difference among the actual differences as the target size.

As some implementations of the present disclosure, the processing unit 102 is used for determining a capture size with the ratio of width to height equal to that of the parent view size among the at least one capture size according to the parent view size acquired by the acquisition unit 101.

As some implementations of the present disclosure, the processing unit 102 is further used for controlling the acquisition unit 101 to acquire the number of interaction objects who have joined the interaction in response to an interaction success instruction.

As some implementations of the present disclosure, the target size is any one of the at least one capture size.

All related contents of steps involved in the above method embodiment can be quoted to the functional descriptions of the corresponding functional modules, and their functions are not repeated here.

Certainly, the image display apparatus 10 provided by the embodiment of the present disclosure includes but is not limited to the above modules. For example, the image display apparatus 10 can further include a storage unit 103. The storage unit 103 can be used for storing program codes of the image display apparatus 10, and can also be used for storing data generated by the image display apparatus 10 during operation, such as data in a write request.

FIG. 8 is a schematic structural diagram of an electronic device provided by an embodiment of the present disclosure. As shown in FIG. 8, the electronic device can include: at least one processor 51, a memory 52, a communication interface 53, a communication bus 54, and a display 55.

Next, with reference to FIG. 8, various component parts of electronic device are introduced.

The processor 51 is a control center of the electronic device, which can be one processor or a collective name of a plurality of processing elements. For example, the processor 51 is a Central Processing Unit (CPU), an Application Specific Integrated Circuit (ASIC), or one or more integrated circuits configured to implement the embodiments of the present disclosure, such as one or more DSPs, or one or more Field Programmable Gate Arrays (FPGAs).

In an implementation, as an embodiment, the processor 51 can include one or more CPUs, such as CPU0 and CPU1 shown in FIG. 8. Also, as an embodiment, the electronic device can include a plurality of processors, such as the processor 51 and the processor 56 shown in FIG. 8. Each of these processors can be a Single-CPU or a Multi-CPU. The processors herein can refer to one or more devices, circuits, and/or processing cores for processing data (e.g., computer program instructions).

The memory 52 can be a Read-Only Memory (ROM) or other type of static storage device that can store static information and instructions, a Random Access Memory (RAM) or other type of dynamic storage device that can store information and instructions, an Electrically Erasable Programmable Read-Only Memory (EEPROM), a Compact Disc Read-Only Memory (CD-ROM) or other optical disk storage, optical disk storage (including compact disks, laser disks, optical disks, digital versatile disks, Blu-ray disks, etc.), a magnetic disk storage medium or other magnetic storage device, or any other medium that can be used to carry or store desired program codes in the form of instructions or data structures and can be accessed by a computer, but is not limited to this. The memory 52 can exist independently and is connected with the processor 51 through a communication bus 54. The memory 52 can also be integrated with the processor 51.

In the implementation, the memory 52 is used for storing data in the present disclosure and executing software programs in the present disclosure. The processor 51 can execute various functions of the air conditioner by operating or executing software programs stored in the memory 52 and calling data stored in the memory 52.

The communication interface 53 uses any device such as a transceiver for communicating with other devices or communication networks, such as a Radio Access Network (RAN), a Wireless Local Area Network (WLAN), a terminal, a cloud and the like. The communication interface 53 can include an acquisition unit to realize the acquisition function.

The communication bus 54 can be an Industry Standard Architecture (ISA) bus, a Peripheral Component Interconnect (PCI) bus, an Extended Industry Standard Architecture (EISA) bus, or the like. The bus can be divided into an address bus, data bus, a control bus, and the like. For convenience of representation, only one thick line is shown in FIG. 8, but it does not mean that there is only one bus or one type of bus.

As one example, in combination with FIG. 7, the acquisition unit 101 in the image display apparatus 10 realizes the same function as the communication interface 53 in FIG. 8, the processing unit 102 in the image display apparatus 10 realizes the same function as the processor 51 in FIG. 8, and the storage unit 103 in the image display apparatus 10 realizes the same function as the memory 52 in FIG. 8.

Another embodiment of the present disclosure also provides a computer readable storage medium storing thereon a computer program which, when executed by a computing device, causes the computing device to implement the image display method as shown in the above method embodiment.

In some embodiments, the disclosed method can be implemented as computer program instructions encoded on a computer readable storage medium or on other non-transitory medium or article in a machine readable format.

Another embodiment of the present disclosure also provides a computer program, including: instructions which, when executed by a processor, causes the processor to execute the image display method provided in the above first aspect.

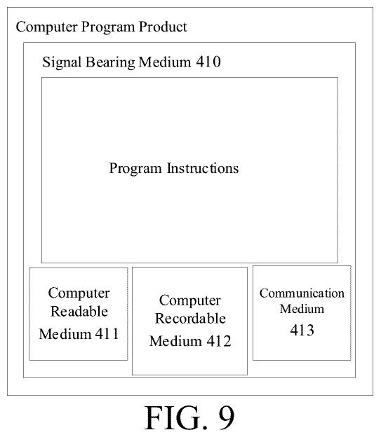

FIG. 9 schematically shows a conceptual partial view of a computer program product provided by an embodiment of the present disclosure. The computer program product includes a computer program for executing a computer process on a computing device.

In one embodiment, a computer program product is provided using a signal bearing medium 410. The signal bearing medium 410 can include one or more program instructions which, when operated by one or more processors, can provide the functions described above for FIG. 2, or a portion of the functions. Thus, for example, referring to the embodiment shown in FIG. 2, one or more features of S11-S14 can be undertaken by one or more instructions associated with the signal bearing medium 410. In addition, the program instructions in FIG. 9 also describe example instructions.

In some examples, the signal bearing medium 410 can include a computer readable medium 411, such as, but not limited to, a hard disk driver, a compact disc (CD), a digital video disc (DVD), a digital tape, a memory, a read-only memory (ROM) or a random access memory (RAM), and the like.

In some embodiments, the signal bearing medium 410 can contain a computer recordable medium 412, such as, but not limited to, a memory, a read/write (R/W) CD, an R/W DVD, and the like.

In some embodiments, the signal bearing medium 410 can contain a communication medium 413, such as, but not limited to, a digital and/or analog communication medium (e.g., fiber optic cable, waveguide, wired communication link, wireless communication link, etc.).

The signal bearing medium 410 can be transmitted by a communication medium 413 in a wireless form (for example, a wireless communication medium that complies with the IEEE 802.41 standard or other transmission protocols). One or more program instructions can be, for example, computer executable instructions or logic implementation instructions.

In some examples, the image display apparatus 10 described for FIG. 7, for example, can be configured to provide various operations, functions, or actions in response to one or more program instructions in the computer readable medium 411, the computer recordable medium 412, and/or the communication medium 413.

Through the description of the above implementation, it can be clearly understood by those skilled in the art that for the convenience and conciseness of description, only the division of the above functional modules is taken as an example. In a practical application, the above functions can be allocated to different functional modules according to needs, that is, the internal structure of the apparatus is divided into different functional modules to complete all or a portion of the functions described above.

In several embodiments provided by the present disclosure, it should be understood that the revealed apparatus and method can be implemented in other ways. For example, the apparatus embodiment described above is only schematic. For example, the division of the modules or units is only a logical function division. In an actual implementation, there can be another division method, for example, a plurality of units or components can be combined or integrated into another apparatus, or some features can be ignored or not implemented. On the other hand, the mutual coupling or direct coupling or communication connection shown or discussed can be indirect coupling or communication connection through some interfaces, apparatuses or units, which can be electrical, mechanical or other forms.

The units described as separate components can or cannot be physically separated, and the components displayed as units can be one or a plurality of physical units, that is, they can be located in one place or distributed to a plurality of different places. A portion or all of the units can be selected according to actual needs to achieve the purpose of the present embodiment.

In addition, the functional units in the embodiments of the present disclosure can be integrated into one processing unit, or exist physically alone, or two or more units can be integrated into one unit. The above integrated units can be implemented in the form of hardware or software functional units.

The integrated units can be stored in a readable storage medium if they are implemented in the form of software functional units and sold or used as independent products. Based on this understanding, the portion of the technical solution, which makes contribution in essence or relative to the related art, of the embodiment of the present disclosure, or the entirety or a portion of the technical solution can be embodied in the form of a software product, which is stored in a storage medium and includes several instructions to cause a device (which can be a single chip, chip, etc.) or a processor to execute all or a portion of steps of the method described in various embodiments of the present disclosure. The aforementioned storage medium includes: U disk, mobile hard disk, ROM, RAM, magnetic disk or optical disk and other media that can store program codes.

What has been described above is only the specific implementations of the present disclosure, so that those skilled in the art can understand or implement the present disclosure. Many modifications to these embodiments will be obvious to those skilled in the art, and the general principles defined herein can be implemented in other embodiments without departing from the spirit or scope of the present disclosure. Therefore, the present disclosure will not be limited to these embodiments described herein, but is to be accorded the widest scope consistent with the principles and novel features disclosed herein.

What is claimed is:

1. An image display method, comprising:
acquiring a parent view size and an actual capture size of a current camera in response to a change in a number of interaction objects, wherein the parent view size indicates a size of a preview box of an image of an interaction object displayed on an interaction interface;
in response to the parent view size being different from the actual capture size, acquiring at least one capture size supported by the current camera;
determining a target size according to the parent view size and the at least one capture size;
updating the parent view size to the target size, and adjusting the actual capture size of the current camera to the target size, according to the target size.

2. The image display method according to claim 1, wherein, the determining a target size according to the parent view size and the at least one capture size, comprises:
determining at least one capture size meeting a preset condition from the at least one capture size according to the parent view size;
determining the target size according to the at least one capture size meeting the preset condition and the parent view size.

3. The image display method according to claim 2, wherein, the determining at least one capture size meeting a preset condition from the at least one capture size according to the parent view size, comprises:
determining a capture size with a ratio of width to height equal to that of the parent view size from the at least one capture size according to the parent view size.

4. The image display method according to claim 2, wherein, the determining the target size according to the at least one capture size meeting the preset condition and the parent view size, comprises:
determining an actual difference between a width in the parent view size and that in the at least one capture size meeting the preset condition, according to the at least one capture size meeting the preset condition and the parent view size;
determining the capture size corresponding to a minimum actual difference from the actual differences as the target size.

5. The image display method according to claim 1, before the acquiring a parent view size and an actual capture size of a current camera in response to a change in a number of interaction objects, the image display method further comprises:
in response to an interaction success instruction, acquiring the number of the interaction objects having joined the interaction.

6. The image display method according to claim 1, wherein the target size is any one of the at least one capture size.

7. The image display method according to claim 1, wherein, the acquiring a parent view size and an actual capture size of a current camera in response to a change in a number of interaction objects, comprises:
in response to the number of the interaction objects being greater than a threshold, acquiring the parent view size and the actual capture size of the current camera in response to the change in the number of interaction objects.

8. The image display method according to claim 7, wherein the threshold is equal to a minimum number of the interaction objects which causes preview pictures of images of the interaction objects to be stretched or compressed.

9. An electronic device, comprising: a memory and a processor, wherein the memory is used for storing a computer program; the processor is used for causing, when executing the computer program, the electronic device to implement an image display method comprising:
acquiring a parent view size and an actual capture size of a current camera in response to a change in a number of interaction objects, wherein the parent view size indicates a size of a preview box of an image of an interaction object displayed on an interaction interface;
in response to the parent view size being different from the actual capture size, acquiring at least one capture size supported by the current camera;
determining a target size according to the parent view size and the at least one capture size;
updating the parent view size to the target size, and adjusting the actual capture size of the current camera to the target size, according to the target size.

10. The electronic device according to claim 9, wherein, the determining a target size according to the parent view size and the at least one capture size, comprises:
determining at least one capture size meeting a preset condition from the at least one capture size according to the parent view size;
determining the target size according to the at least one capture size meeting the preset condition and the parent view size.

11. The electronic device according to claim 10, wherein, the determining at least one capture size meeting a preset condition from the at least one capture size according to the parent view size, comprises:
determining a capture size with a ratio of width to height equal to that of the parent view size from the at least one capture size according to the parent view size.

12. The electronic device according to claim 10, wherein, the determining the target size according to the at least one capture size meeting the preset condition and the parent view size, comprises:
determining an actual difference between a width in the parent view size and that in the at least one capture size meeting the preset condition, according to the at least one capture size meeting the preset condition and the parent view size;
determining the capture size corresponding to a minimum actual difference from the actual differences as the target size.

13. The electronic device according to claim 9, before the acquiring a parent view size and an actual capture size of a current camera in response to a change in a number of interaction objects, the image display method further comprises:
in response to an interaction success instruction, acquiring the number of the interaction objects having joined the interaction.

14. The electronic device according to claim 9, wherein the target size is any one of the at least one capture size.

15. A non-transitory computer readable storage medium, wherein, on the computer readable storage medium is stored a computer program which, when executed by a computing device, causes the computing device to implement an image display method comprising:
acquiring a parent view size and an actual capture size of a current camera in response to a change in a number of interaction objects, wherein the parent view size indicates a size of a preview box of an: image of an interaction object displayed on an interaction interface;
in response to the parent view size being different from the actual capture size, acquiring at least one capture size supported by the current camera;
determining a target size according to the parent view size and the at least one capture size;
updating the parent view size to the target size, and adjusting the actual capture size of the current camera to the target size, according to the target size.

16. The non-transitory computer readable storage medium according to claim 15, wherein, the determining a target size according to the parent view size and the at least one capture size, comprises:
determining at least one capture size meeting a preset condition from the at least one capture size according to the parent view size;
determining the target size according to the at least one capture size meeting the preset condition and the parent view size.

17. The non-transitory computer readable storage medium according to claim 16, wherein, the determining at least one capture size meeting a preset condition from the at least one capture size according to the parent view size, comprises:
determining a capture size with a ratio of width to height equal to that of the parent view size from the at least one capture size according to the parent view size.

18. The non-transitory computer readable storage medium according to claim 16, wherein, the determining the target size according to the at least one capture size meeting the preset condition and the parent view size, comprises:
determining an actual difference between a width in the parent view size and that in the at least one capture size meeting the preset condition, according to the at least one capture size meeting the preset condition and the parent view size;
determining the capture size corresponding to a minimum actual difference from the actual differences as the target size.

19. The non-transitory computer readable storage medium according to claim 15, before the acquiring a parent view size and an actual capture size of a current camera in response to a change in a number of interaction objects, the image display method further comprises:
in response to an interaction success instruction, acquiring the number of the interaction objects having joined the interaction.

20. The non-transitory computer readable storage medium according to claim 15, wherein the target size is any one of the at least one capture size.
